(19) United States
(12) Patent Application Publication
(10) Pub. No.: US 2026/0101252 A1
(43) Pub. Date: Apr. 9, 2026

(54) METHOD AND APPARATUS FOR CELL SWITCHING OPERATIONS

(71) Applicant: SHARP KABUSHIKI KAISHA, Sakai City, Osaka (JP)

(72) Inventors: CHIA-HUNG LIN, Taipei (TW); MEI-JU SHIH, Taipei (TW); HUNG-CHEN CHEN, Taipei (TW); WAN-CHEN LIN, Taipei (TW)

(21) Appl. No.: 19/116,084

(22) PCT Filed: Sep. 27, 2023
(86) PCT No.: PCT/CN2023/122049

§ 371 Date: Mar. 27, 2025

Related U.S. Application Data
(60) Provisional application No. 63/412,011, filed on Sep. 30, 2022.

(51) Int. Cl. H04W 36/08; H04W 56/00; H04W 80/02

(52) U.S. Cl. CPC H04W 36/08; H04W 56/0015; H04W 56/0045; H04W 80/02

(57) ABSTRACT

A method and apparatuses for cell switching operations are provided. The method includes receiving one or more Timing Advance Group (TAG) Identities (IDs) from a source serving cell: receiving one or more Time Alignment Timers (TATs) from the source serving cell: receiving a Medium Access Control (MAC) Control Element (CE) from the source serving cell, the MAC CE indicating to the UE to switch to a target serving cell, the target serving cell being a candidate target serving cell of the one or more candidate target serving cells and associated with a TAT of the one or more TATs; switching from the source serving cell to the target serving cell in response to receiving the MAC CE; and keeping the TAT associated with the target serving cell running after receiving the MAC CE.

### CROSS-REFERENCE TO RELATED APPLICATION(S)

The present disclosure claims the benefit of and priority to U.S. Provisional Patent Application Ser. No. 63/412,011, filed on Sep. 30, 2022, entitled “MECHANISMS FOR SUPPORTING MULTI-TAS FOR L1/L2 MOBILITY,” the content of which is hereby incorporated herein fully by reference into the present disclosure for all purposes.

### FIELD

The present disclosure is related to wireless communication and, more specifically, to a method and apparatuses for cell switching operations.

### BACKGROUND

Various efforts have been made to improve different aspects of wireless communication for cellular wireless communication systems, such as 5^{th} Generation (5G) New Radio (NR), by improving data rate, latency, reliability, and mobility. The 5G NR system is designed to provide flexibility and configurability to optimize network services and types, accommodating various use cases, such as enhanced Mobile Broadband (eMBB), massive Machine-Type Communication (mMTC), and Ultra-Reliable and Low-Latency Communication (URLLC). However, as the demand for radio access continues to increase, there exists a need for further improvements in the art.

### SUMMARY

The present disclosure is related to a method and apparatuses for cell switching operations.

In a first aspect of the present disclosure, a method performed by a User Equipment (UE) for cell switching operations is provided. The method includes receiving one or more Timing Advance Group (TAG) Identities (IDs) from a source serving cell, the one or more TAG IDs associated with one or more candidate target serving cell configurations of one or more candidate target serving cells; receiving one or more Time Alignment Timers (TATs) from the source serving cell, each TAT of the one or more TATs associated with a respective TAG ID of the one or more TAG IDs; receiving a Medium Access Control (MAC) Control Element (CE) from the source serving cell, the MAC CE indicating to the UE to switch to a target serving cell, the target serving cell being a candidate target serving cell of the one or more candidate target serving cells, the target serving cell associated with a TAT of the one or more TATs; switching from the source serving cell to the target serving cell in response to receiving the MAC CE; and keeping the TAT associated with the target serving cell running after receiving the MAC CE.

In some implementations of the first aspect of the present disclosure, each candidate target serving cell configuration of the one or more candidate target serving cell configurations is associated with a Synchronization Signal and Physical Broadcast Channel Block (SSB) configuration that indicates at least one of an SSB burst set, a transmission power of an SSB, or a periodicity of the SSB.

In some implementations of the first aspect of the present disclosure, the source serving cell is associated with a first Physical Cell Identity (PCI), and the target serving cell is associated with a second PCI that is different from the first PCI of the serving cell.

In some implementations of the first aspect of the present disclosure, the MAC CE includes a field that indicates the target serving cell.

In a second aspect of the present disclosure, a User Equipment (UE) for cell switching operations is provided. The UE includes at least one processor and at least one memory coupled to the at least one processor. The at least one memory stores one or more computer-executable instructions that, when executed by the at least one processor, cause the UE to: receive one or more Timing Advance Group (TAG) Identities (IDs) from a source serving cell, the one or more TAG IDs associated with one or more candidate target serving cell configurations of one or more candidate target serving cells; receive one or more Time Alignment Timers (TATs) from the source serving cell, each TAT of the one or more TATs associated with a respective TAG ID of the one or more TAG IDs; receive a Medium Access Control (MAC) Control Element (CE) from the source serving cell, the MAC CE indicating to the UE to switch to a target serving cell, the target serving cell being a candidate target serving cell of the one or more candidate target serving cells, the target serving cell associated with a TAT of the one or more TATs; switch from the source serving cell to the target serving cell in response to receiving the MAC CE; and keep the TAT associated with the target serving cell running after receiving the MAC CE.

In some implementations of the second aspect of the present disclosure, each candidate target serving cell configuration of the one or more candidate target serving cell configurations is associated with a Synchronization Signal and Physical Broadcast Channel Block (SSB) configuration that indicates at least one of an SSB burst set, a transmission power of an SSB, or a periodicity of the SSB.

In some implementations of the second aspect of the present disclosure, the source serving cell is associated with a first Physical Cell Identity (PCI), and the target serving cell is associated with a second PCI that is different from the first PCI of the serving cell.

In some implementations of the second aspect of the present disclosure, the MAC CE includes a field that indicates the target serving cell.

In a third aspect of the present disclosure, a Base Station (BS) for managing cell switching operations of a User Equipment (UE) is provided. The BS includes at least one processor and at least one memory coupled to the at least one processor. The at least one memory stores one or more computer-executable instructions that, when executed by the at least one processor, cause the UE to: configure the UE with one or more Timing Advance Group (TAG) Identities (IDs), the one or more TAG IDs associated with one or more candidate target serving cell configurations of one or more candidate target serving cells; configure the UE with one or more Time Alignment Timers (TATs), each TAT of the one or more TATs associated with a respective TAG ID of the one or more TAG IDs; transmit a Medium Access Control (MAC) Control Element (CE) to the UE, the MAC CE indicating to the UE to switch to a target serving cell, the target serving cell being a candidate target serving cell of the one or more candidate target serving cells, the target serving cell associated with a TAT of the one or more TATs; where the TAT associated with the target serving cell is configured to keep running after the UE receives the MAC CE.

In some implementations of the third aspect of the present disclosure, each candidate target serving cell configuration of the one or more candidate target serving cell configurations is associated with a Synchronization Signal and Physical Broadcast Channel Block (SSB) configuration that indicates at least one of an SSB burst set, a transmission power of an SSB, or a periodicity of the SSB.

In some implementations of the third aspect of the present disclosure, the BS provides a source serving cell that is associated with a first Physical Cell Identity (PCI), and the target serving cell is associated with a second PCI that is different from the first PCI of the source serving cell.

In some implementations of the third aspect of the present disclosure, the MAC CE includes a field that indicates the target serving cell.

### BRIEF DESCRIPTION OF THE DRAWINGS

Aspects of the present disclosure are best understood from the following detailed disclosure when read with the accompanying drawings. Various features are not drawn to scale. Dimensions of various features may be arbitrarily increased or reduced for clarity of discussion.

FIG. 1 is a diagram illustrating a handover procedure, according to an example implementation of the present disclosure.

FIG. 2 is a diagram illustrating a method for Layer 1 (L1)/Layer 2 (L2) mobility operations, according to an example implementation of the present disclosure.

FIG. 3 is a flowchart of a method for cell switching operations, according to an example implementation of the present disclosure.

FIG. 4 is a block diagram illustrating a node for wireless communication, according to an example implementation of the present disclosure.

### DESCRIPTION

Some of the abbreviations used in this disclosure include:

| Abbreviation | Full name |
|---|---|
| 3GPP | 3^{rd} Generation Partnership Project |
| 5G | 5^{th} Generation |
| 5GC | 5G Core |
| ARFCN | Absolute Radio-Frequency Channel Number |
| AS | Access Stratum |
| ASN.1 | Abstract Syntax Notation One |
| BS | Base Station |
| BWP | Bandwidth Part |
| CA | Carrier Aggregation |
| CAG | Closed Access Group |
| CG | Configured Grant |
| CJT | Coherent Joint Transmission |
| CN | Core Network |
| CSI-RS | Channel State Information-Reference Signal |
| CU | Central Unit |
| DAPS | Dual Active Protocol Stack |
| DC | Dual Connectivity |
| DCI | Downlink Control Information |
| DL | Downlink |
| DMRS | Demodulation Reference Signal |
| DRB | Data Radio Bearer |
| DU | Distributed Unit |
| E-UTRA(N) | Evolved Universal Terrestrial Radio Access (Network) |
| EN-DC | E-UTRA NR Dual Connectivity |
| EPC | Evolved Packet Core |
| eMTC | enhanced Machine Type Communication |
| FDD | Frequency Division Duplexing |
| FR1 | Frequency Range 1 |
| FR2 | Frequency Range 2 |
| GEO | Geostationary Equatorial Orbit |
| GNSS | Global Navigation Satellite System |
| GW | Gateway |
| HARQ | Hybrid Automatic Repeat Request |
| HO | Handover |
| FR | Frequency Range |
| IAB | Integrated Access and Backhaul |
| ID | Identity |
| IE | Information Element |
| IoT | Internet of Things |
| ITS | Intelligent Transportation System |
| L1 | Layer 1 |
| L2 | Layer 2 |
| LAN | Local Area Network |
| LCID | Logical Channel ID |
| LEO | Low Earth Orbit |
| LTE | Long Term Evolution |
| MAC | Medium Access Control |
| MAC CE | MAC Control Element |
| MCG | Master Cell Group |
| MIB | Master Information Block |
| MN | Master Node |
| MSG | Message |
| MSG1 | Message 1 |
| MSG2 | Message 2 |
| MSG3 | Message 3 |
| MSG4 | Message 4 |
| MSGA | Message A |
| MSGB | Message B |
| MT | Mobile Termination |
| MTC | Machine Type Communication |
| NAS | Non-Access Stratum |
| NB-IoT | Narrow Band Internet of Things |
| NE-DC | NR - E-UTRA Dual Connectivity |
| NPN | Non-Public Network |
| NR | New Radio |
| NR-U | NR Unlicensed |
| NTN | Non-Terrestrial Network |
| NW | Network |
| PBCH | Physical Broadcast Channel |
| PCell | Primary Cell |
| PCI | Physical Cell Identity |
| PDCCH | Physical Downlink Control Channel |
| PDCP | Packet Data Convergence Protocol |
| PDSCH | Physical Downlink Shared Channel |
| PDU | Protocol Data Unit |
| PHY | Physical (layer) |
| PLMN | Public Land Mobile Network |
| PNI-NPN | Public Network Integrated Non-Public Network |
| PRACH | Physical Random Access Channel |
| PSCell | Primary SCG Cell/Primary Secondary Cell |
| PUCCH | Physical Uplink Control Channel |
| PUSCH | Physical Uplink Shared Channel |
| RA | Random Access |
| RACH | Random Access Channel |
| RAN | Radio Access Network |
| RAR | Random Access Response |
| RAT | Radio Access Technology |
| RF | Radio Frequency |
| RLC | Radio Link Control |
| RSTD | Reference Signal Time Difference Measurement |
| RNTI | Radio Network Temporary Identifier |
| RO | RACH Occasion |
| RRC | Radio Resource Control |
| RS | Reference Signal |
| RSRP | Reference Signal Received Power |
| RSRQ | Reference Signal Receiving Quality |
| SCell | Secondary Cell |
| SCG | Secondary Cell Group |
| SDT | Small Data Transmission |
| SI | System Information |
| SIB | System Information Block |
| SL | Sidelink |
| SN | Secondary Node |
| SNPN | Stand-alone Non-Public Network |
| SR | Scheduling Request |
| SRB | Signaling Radio Bearer |
| SSB | Synchronization Signal and PBCH Block |
| SUL | Supplementary Uplink |
| TA | Timing Advance |
| TAG | Timing Advance Group |
| TAT | Time Alignment Timer |
| TCI | Transmission Configuration Indication |
| TDD | Time Division Duplexing |
| TN | Terrestrial Network |
| TRP | Transmission Reception Point |
| TRS | Tracking Reference Signal |
| TS | Technical Specification |
| TX | Transmission |
| UE | User Equipment |
| UL | Uplink |
| UL-CG | Uplink-Configured Grant |
| USIM | Universal Subscriber Identity Module |
| V2X | Vehicle-to-Everything |
| VSAT | Very Small Aperture Terminal |

The following contains specific information related to implementations of the present disclosure. The drawings and their accompanying detailed disclosure are merely directed to implementations. However, the present disclosure is not limited to these implementations. Other variations and implementations of the present disclosure will be obvious to those skilled in the art.

Unless noted otherwise, like or corresponding elements among the drawings may be indicated by like or corresponding reference numerals. Moreover, the drawings and illustrations in the present disclosure are generally not to scale and are not intended to correspond to actual relative dimensions.

For consistency and case of understanding, like features may be identified (although, in some examples, not illustrated) by the same numerals in the drawings. However, the features in different implementations may be different in other respects and shall not be narrowly confined to what is illustrated in the drawings.

References to “one implementation,” “an implementation,” “example implementation,” “various implementations,” “some implementations,” “implementations of the present application,” etc., may indicate that the implementation(s) of the present application so described may include a particular feature, structure, or characteristic, but not every possible implementation of the present application necessarily includes the particular feature, structure, or characteristic. Further, repeated use of the phrase “in one implementation.” or “in an example implementation.” “an implementation,” do not necessarily refer to the same implementation, although they may. Moreover, any use of phrases like “implementations” in connection with “the present application” are never meant to characterize that all implementations of the present application must include the particular feature, structure, or characteristic, and should instead be understood to mean “at least some implementations of the present application” includes the stated particular feature, structure, or characteristic. The term “coupled” is defined as connected, whether directly or indirectly through intervening components, and is not necessarily limited to physical connections. The term “comprising.” when utilized, means “including, but not necessarily limited to”; it specifically indicates open-ended inclusion or membership in the so-described combination, group, series, and the equivalent.

The expression “at least one of A, B and C” or “at least one of the following: A, B and C” means “only A, or only B, or only C, or any combination of A, B and C.” The terms “system” and “network” may be used interchangeably. The term “and/or” is only an association relationship for describing associated objects and represents that three relationships may exist such that A and/or B may indicate that A exists alone, A and B exist at the same time, or B exists alone. The character “/” generally represents that the associated objects are in an “or” relationship.

For the purposes of explanation and non-limitation, specific details, such as functional entities, techniques, protocols, and standards, are set forth for providing an understanding of the disclosed technology. In other examples, detailed disclosure of well-known methods, technologies, systems, and architectures are omitted so as not to obscure the present disclosure with unnecessary details.

Persons skilled in the art will immediately recognize that any network function(s) or algorithm(s) disclosed may be implemented by hardware, software, or a combination of software and hardware. Disclosed functions may correspond to modules which may be software, hardware, firmware, or any combination thereof.

A software implementation may include computer executable instructions stored on a computer-readable medium, such as memory or other type of storage devices. One or more microprocessors or general-purpose computers with communication processing capability may be programmed with corresponding executable instructions and perform the disclosed network function(s) or algorithm(s).

The microprocessors or general-purpose computers may include Application-Specific Integrated Circuits (ASICs), programmable logic arrays, and/or one or more Digital Signal Processor (DSPs). Although some of the disclosed implementations are oriented to software installed and executing on computer hardware, alternative implementations implemented as firmware, as hardware, or as a combination of hardware and software are well within the scope of the present disclosure. The computer-readable medium includes but is not limited to Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture such as a Long-Term Evolution (LTE) system, an LTE-Advanced (LTE-A) system, an LTE-Advanced Pro system, or a 5G NR Radio Access Network (RAN) typically includes at least one base station (BS), at least one UE, and one or more optional network elements that provide connection within a network. The UE communicates with the network such as a Core Network (CN), an Evolved Packet Core (EPC) network, an Evolved Universal Terrestrial RAN (E-UTRAN), a 5G Core (5GC), or an internet via a RAN established by one or more BSs.

A UE may include, but is not limited to, a mobile station, a mobile terminal or device, or a user communication radio terminal. The UE may be a portable radio equipment that includes, but is not limited to, a mobile phone, a tablet, a wearable device, a sensor, a vehicle, or a Personal Digital Assistant (PDA) with wireless communication capability. The UE is configured to receive and transmit signals over an air interface to one or more cells in a RAN.

The BS may be configured to provide communication services according to at least a Radio Access Technology (RAT) such as Worldwide Interoperability for Microwave Access (WiMAX), Global System for Mobile communications (GSM) that is often referred to as 2G, GSM Enhanced Data rates for GSM Evolution (EDGE) RAN (GERAN), General Packet Radio Service (GPRS), Universal Mobile Telecommunication System (UMTS) that is often referred to as 3G based on basic wideband-code division multiple access (W-CDMA), high-speed packet access (HSPA), LTE, LTE-A, evolved LTE (eLTE) that is LTE connected to 5GC, NR (often referred to as 5G), and/or LTE-A Pro. However, the scope of the present disclosure is not limited to these protocols.

The BS may include, but is not limited to, a node B (NB) in the UMTS, an evolved node B (eNB) in LTE or LTE-A, a radio network controller (RNC) in UMTS, a BS controller (BSC) in the GSM/GERAN, an ng-eNB in an Evolved Universal Terrestrial Radio Access (E-UTRA) BS in connection with 5GC, a next generation Node B (gNB) in the 5G-RAN, or any other apparatus capable of controlling radio communication and managing radio resources within a cell. The BS may serve one or more UEs via a radio interface.

The BS is operable to provide radio coverage to a specific geographical area using a plurality of cells forming the RAN. The BS supports the operations of the cells. Each cell is operable to provide services to at least one UE within its radio coverage.

Each cell (often referred to as a serving cell) provides services to serve one or more UEs within its radio coverage such that each cell schedules the DL and optionally UL resources to at least one UE within its radio coverage for DL and optionally UL packet transmissions. The BS may communicate with one or more UEs in the radio communication system via the plurality of cells.

A cell may allocate sidelink (SL) resources for supporting Proximity Service (ProSe) or Vehicle to Everything (V2X) service. Each cell may have overlapped coverage areas with other cells.

In Multi-RAT Dual Connectivity (MR-DC) cases, the primary cell of a Master Cell Group (MCG) or a Secondary Cell Group (SCG) may be called a Special Cell (SpCell). A Primary Cell (PCell) may refer to the SpCell of an MCG. A Primary SCG Cell (PSCell) may refer to the SpCell of an SCG. MCG may refer to a group of serving cells associated with the Master Node (MN), including the SpCell and optionally one or more Secondary Cells (SCells). An SCG may refer to a group of serving cells associated with the Secondary Node (SN), including the SpCell and optionally one or more SCells.

As previously disclosed, the frame structure for NR supports flexible configurations for accommodating various next generation (e.g., 5G) communication requirements, such as Enhanced Mobile Broadband (eMBB), Massive Machine Type Communication (mMTC), and Ultra-Reliable and Low-Latency Communication (URLLC), while fulfilling high reliability, high data rate, and low latency requirements. The Orthogonal Frequency-Division Multiplexing (OFDM) technology in the 3GPP may serve as a baseline for an NR waveform. The scalable OFDM numerology, such as adaptive sub-carrier spacing, channel bandwidth, and Cyclic Prefix (CP), may also be used.

Two coding schemes are considered for NR, specifically Low-Density Parity-Check (LDPC) code and Polar Code. The coding scheme adaption may be configured based on channel conditions and/or service applications.

At least DL transmission data, a guard period, and a UL transmission data should be included in a transmission time interval (TTI) of a single NR frame. The respective portions of the DL transmission data, the guard period, and the UL transmission data should also be configurable based on, for example, the network dynamics of NR. SL resources may also be provided in an NR frame to support ProSe services or V2X services.

Any two or more than two of the following paragraphs, (sub)-bullets, points, actions, behaviors, terms, or claims described in the present disclosure may be combined logically, reasonably, and properly to form a specific method.

Any sentence, paragraph, (sub)-bullet, point, action, behaviors, terms, or claims described in the present disclosure may be implemented independently and separately to form a specific method.

Dependency, e.g., “based on”, “more specifically”, “preferably”, “in one embodiment”, “in some implementations”, etc., in the present disclosure is just one possible example which would not restrict the specific method.

“A and/or B” in the present disclosure may refer to either A or B, both A and B, at least one of A and B.

Examples of some selected terms in the present disclosure are provided as follows.

Antenna Panel: It may be assumed that an antenna panel is an operational unit for controlling a transmit spatial filter/beam. An antenna panel is typically consisted of a plurality of antenna elements. A beam can be formed by an antenna panel and in order to form two beams simultaneously, two antenna panels are needed. Such simultaneous beamforming from multiple antenna panels is subject to the UE capability. A similar definition for “antenna panel” may be possible by applying spatial receiving filtering characteristics.

Beam: The term “beam” here may be replaced with spatial filter. For example, when a UE reports a preferred gNB TX beam, the UE is essentially selecting a spatial filter used by the gNB. The term “beam information” may be used to provide information about which beam/spatial filter has been used/selected. An apparatus (e.g., a UE or a BS) may transmit individual reference signals by applying individual beams (spatial filters). Thus, a beam (or beam information) may be represented by reference signal resource index (cs).

DCI: DCI stands for Downlink Control Information. Various DCI formats are used in LTE within the PDCCH. A DCI format may be a predefined format that packages or forms the downlink control information for transmission in the PDCCH.

TCI State: A TCI state may contain parameters for configuring a QCL relationship between one or two reference signals and a target reference signal set. For example, a target reference signal set may be the DM-RS ports of the PDSCH, PDCCH, PUCCH or PUSCHI.

HARQ: HARQ functionality ensures reliable delivery between peer entities at Layer 1 (L1) (e.g., the Physical Layer). When the physical layer is not configured for downlink/uplink spatial multiplexing, a single HARQ process supports one Transport Block (TB). When the physical layer is configured for downlink/uplink spatial multiplexing, a single HIARQ process may support one or multiple TBs. There is one HARQ entity for each serving cell. Each HARQ entity supports a parallel number of downlink (DL) and uplink (UL) HARQ processes.

Additionally, in the present disclosure, the terms “source cell,” “source serving cell,” “source serving beam,” “source beam,” and “source gNB” can be used interchangeably. The terms “target cell,” “target serving cell,” “target serving beam,” “target beam,” and “target gNB” can be used interchangeably.

In NR, handover is one of the key features designed to provide better user experiences and ensure service continuity. The NR handover feature is developed based on LTE handover mechanisms. Specifically, a UE may provide a measurement report to a gNB after/at the time certain measurement report events are triggered. Following this, the gNB may instruct the UE on whether to initiate a handover procedure based on the measurement report. During the handover procedure, the UE may transition from the source gNB to the target gNB.

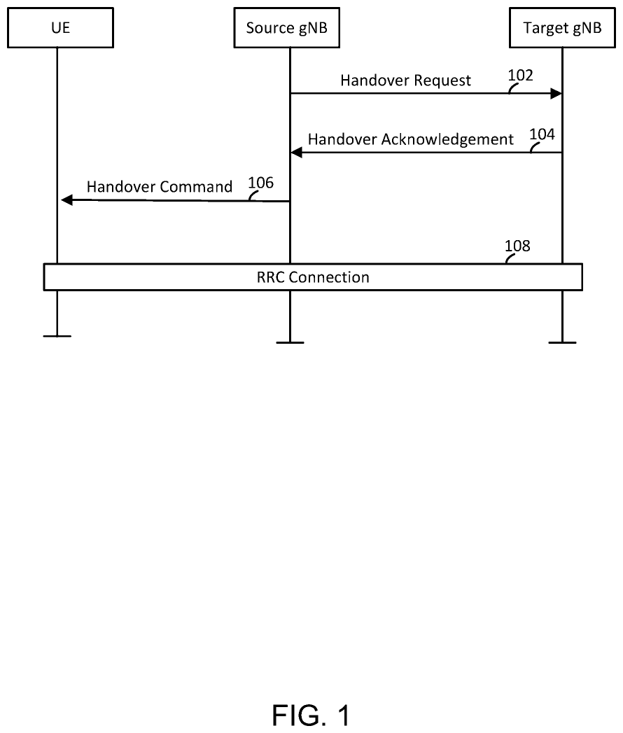

FIG. 1 is a diagram illustrating a handover procedure, according to an example implementation of the present disclosure.

As illustrated in FIG. 1, in action 102, the source gNB may transmit a Handover Request to a target gNB to initiate the handover procedure.

In action 104, the target gNB may transmit a Handover Acknowledgement, as a response to the Handover Request, to the source gNB.

In action 106, the source gNB may transmit a Handover Command to the UE. The Handover Command may include the configurations corresponding to the target gNB. For example, the Handover Command may include (or be included in) an RRC reconfiguration message that includes the configuration of the target gNB received in the Handover Acknowledgement.

In action 108, the UE may access the target cell according to the information/configuration included in the Handover Command, and establish an RRC connection to the target gNB and transmit a Handover Complete message (e.g., an RRC reconfiguration complete message) to the target gNB. Thereafter, the UE may begin receiving DL data from, and transmitting UL data to, the target gNB.

To improve user experience, minimize interruption time, and enhance service continuity, L1/L2 mobility operations are implemented to reduce HO latency in NR. In this context, L1 refers to the Physical layer, while L2 can refer to the MAC, RLC, and/or PDCP layers. The L1/L2 mobility operations may efficiently reduce the latency associated with the traditional HO, as decisions and measurements occur at the L2 and/or L1 layers of devices (e.g., the UE or gNB). Specifically, the L1/L2 mobility operations may refer to a specific type of cell switching operations. When the UE is performing the L1/L2 mobility operations, the primary layers involved in processing the related signaling are L1 and/or L2. By focusing the operations at L1 and/or L2, the device benefits from reduced latency, making the HO or cell switching process more efficient and quicker.

In some implementations, in the L1/L2 mobility operations, the source cell/gNB may initially configure the UE with candidate cells and beam measurement information (e.g., via an RRC reconfiguration message). Subsequently, the UE may perform beam measurement and report the measurement results back to the source cell/gNB. Based on the measurement results, the source cell/gNB may determine whether the UE needs to change the serving cell/beam. If a change of the serving cell/beam is needed, the source cell/gNB may indicate to the UE to change the serving cell/beam. Following the indication from the source cell/gNB, the UE may change the serving cell/beam to a target serving cell/beam. Thereafter, the UE may perform data reception and/or transmission using the target serving cell/beam. For example, the UE may receive DL data via/from the target serving cell/beam and may transmit UL data via/to the target serving cell/beam.

To further reduce the latency caused by performing the L1/L2 mobility operations, the present disclosure proposes several schemes for acquiring the TA information (e.g., the TA value(s)) of the target serving cells in the L1 L2 mobility operations.

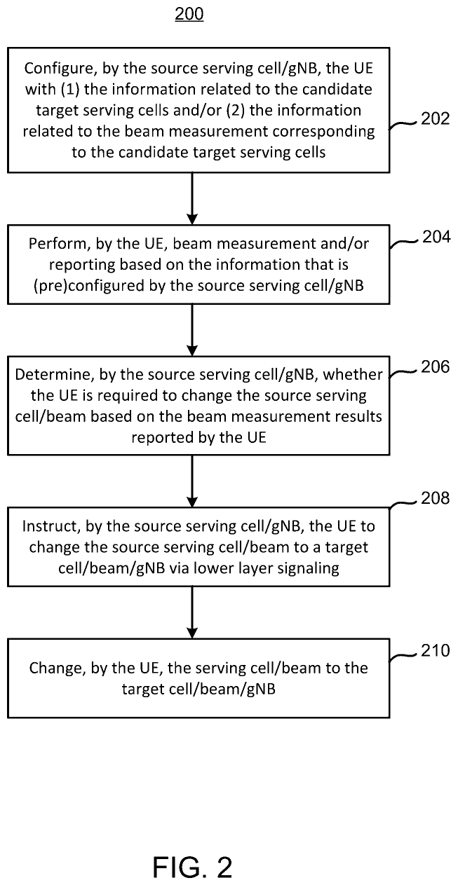

FIG. 2 is a diagram illustrating a method 200 for L1/L2 mobility operations, according to an example implementation of the present disclosure.

In action 202, the source serving cell/gNB may configure the UE with (1) the information associated with (or related to) the candidate target serving cells and/or (2) the information associated with the beam measurement corresponding to the candidate target serving cells.

In action 204, the UE may perform beam measurement and/or reporting based on the information that is (pre) configured by the source serving cell/gNB in action 202.

In action 206, the source serving cell/gNB may determine, based on the beam measurement results reported by the UE, whether the UE is required to change the source serving cell/beam.

In action 208, the source serving cell/gNB may instruct the UE to change the source serving cell/beam to a target cell/beam/gNB via lower layer signaling (e.g., MAC CE and/or DCI signaling).

In action 210, the UE may change the serving cell/beam to the target cell/beam/gNB.

The TA information of the target serving cell may be acquired either before action 206 or after action 206, based on various TA information acquisition mechanisms described in the present disclosure. Additional details for several actions involved in the L1/L2 mobility operations are also provided in the following sections of the present disclosure. Please note that the implementations described in different sections of the present disclosure can be combined with each other. These implementations may pertain to the L1/L2 mobility operations and may describe different or similar aspects of the operations.

### UE Capability

In some implementations, a UE with the capability to perform multi-TRP-based operations, such as multi-TRP-based DL receptions or UL transmissions, may imply that the UE is also capable of performing the L1/L2 mobility operations. For example, if a UE notifies a gNB of its ability to perform multi-TRP-based operations, this also means that the UE informs the gNB that the UE is capable of performing the L1/L2 mobility operations. The multi-TRP-based operations may be single-DCI-based or multi-DCI-based. Specifically, single-DCI-based multi-TRP operations allow using single DCI from one TRP to schedule data across multiple TRPs, while multi-DCI-based multi-TRP operations allow using multiple DCI from multiple TRPs to schedule their respective data. In some implementations, a UE may report one capability for supporting the multi-TRP-based operations in the FDD mode, and another capability for supporting the multi-TRP-based operations in the TDD mode. Additionally, a UE may report one capability for supporting the multi-TRP-based operations on FR1 and another for FR2.

In some implementations, a UE may inform the source gNB (or serving cell) about its capability for supporting the L1/L2 mobility operations. In some implementations, a UE may report one capability for supporting the L1/L2 mobility operations in the FDD mode and another capability for supporting the L1/L2 mobility operations in the TDD mode. In some implementations, a UE may report one capability for supporting the L1/L2 mobility operations on the FR1 and another capability for supporting the L1/L2 mobility operations on the FR2.

In some implementations, a UE capable of performing simultaneous transmissions with multiple (antenna) panels is also enabled for performing the L1/L2 mobility operations. For example, if a UE informs a gNB that it is able to execute the simultaneous transmissions with multiple panels, this also implies that the UE is informing the gNB of its ability to perform the L1/L2 mobility operations. In some implementations, the UE may report one capability for supporting the simultaneous transmissions with multiple panels in the FDD mode, and another capability for supporting the L1/L2 mobility operations in the TDD mode. In some implementations, the UE may report to the network one capability for supporting the simultaneous transmissions with multiple panels on the FR1 and another capability for supporting the simultaneous transmissions with multiple panels on the FR2.

In some implementations, a UE capable of transmitting on the FR2 may also support the L1/L2 mobility operations. For example, if a UE informs the gNB that it is able to perform transmissions on the FR2, this may also mean that the UE informs the gNB that the UE is capable of performing the L1/L2 mobility operations.

In some implementations, the UE may report (e.g., via a UE Capability Information message) to the source cell/gNB various capabilities, such as the capability for performing the multi-TRP based operations, the L1/L2 mobility operations, the simultaneous transmissions with multiple panels, and/or the transmissions on the FR2. The UE may transmit the UE Capability Information message in response to a UE Capability Enquiry message from the source cell/gNB.

In some implementations, if a UE has the capability to perform any of the following operations, it may mean that the UE also supports the L1/L2 mobility operations: multi-TA for multi-DCI, unified TCI framework for multi-TRP schemes, inter-cell beam management, CJT operations (supporting more than two TCI states for a UE), increased number of orthogonal DMRS ports, and 8TX operations.

### Pre-Configuration

In some implementations, in a case that a UE is instructed (e.g., by dedicated signaling or broadcast system information) to perform the L1/L2 mobility operations, the gNB may pre-configure the UE with the information associated with the candidate target serving cells and/or the information associated with the beam measurements corresponding to the candidate target serving cells.

For example, the IEs or (RRC) parameters may be used to provide/represent/indicate the information associated with the candidate target serving cells. The IEs or (RRC) parameters may include, but are not limited to, at least one of the following: one or more TAG IDs, one or more TATs, one or more additional PCI indices (AdditionalPCIIndex), one or more serving cell indices, one or more RACH occasions, one or more SSB burst sets, one or more SSB transmit power values, one or more SSB periodicities, and one or more physical cell IDs. The information associated with the candidate target serving cells may include the necessary information for the UE to access, perform DL synchronization, and/or carry out UL synchronization with the candidate target serving cell(s). A TAT may be associated with a specific TAG ID.

The association/relationship between the information and the candidate target serving cell(s) may be established based on at least one of the following criteria, (1) to (8):
(1) The IE/RRC parameter for providing/representing/indicating the information associated with the candidate target serving cell(s) may include one or more TAG IDs. In some implementations, the information associated with the candidate target serving cell(s) may include a set of cell IDs (e.g., a set of additional PCI indices, serving cell indices, and/or PCIs) identifying a set of cells (e.g., the candidate target serving cells). In some implementations, each TAG ID may be associated with one or more cell IDs. In some implementations, each cell ID may be associated with (only) a single TAG ID.
(2) The IE/RRC parameter for providing/representing/indicating the information associated with the candidate target serving cell(s) may include an additional PCI index and/or the TCI state information. In some implementations, the TCI state information may include an additional PCI index and a TAG ID. In some implementations, the TCI state information, which includes an additional PCI index, may be associated with a TAG ID without necessarily including the TAG ID. In some implementations, the TAG ID may be associated with one or more TCI states. In the present disclosure, a TCI state may refer to a DL TCI state, a UL TCI state, and/or a joint TCI state. Consequently, the TCI state information may correspond to a DL TCI state, a UL TCI state, and/or a joint TCI state.
(3) The IE/RRC parameter for providing/representing/indicating the information associated with the candidate target serving cell(s) may include an additional PCI index (AdditionalPCIIndex) and/or an SSB MTC additional PCI (SSB-MTC-AdditionalPCI). In some implementations, the SSB-MTC-AdditionalPCI that corresponds to the AdditionalPCIIndex may include a TAG ID. In some implementations, the SSB-MTC-AdditionalPCI that corresponds to the AdditionalPCIIndex may be associated with a TAG ID without necessarily including the TAG ID. In some implementations, the TAG ID may be associated with one or more SSB-MTC-AdditionalPCIs that correspond to the AdditionalPCIIndex. In some implementations, an AdditionalPCIIndex may be associated with one or more SSB-MTC-AdditionalPCIs.
(4) The UE may be configured with an IE/RRC parameter (e.g., CandidateServingCellGroup). This IE/RRC parameter may include one or more additional IEs/RRC parameters. Each of the additional IEs/RRC parameters may correspond to a different candidate target serving cell configuration. In some implementations, the CandidateServingCellGroup may include a TAG ID. Specifically, the TAG ID may be associated with one or more candidate target serving cells. In some implementations, the candidate target serving cells (as indicated by the candidate target serving cell configurations in the CandidateServingCellGroup) may be associated with the TAG ID included in the CandidateServingCellGroup. In some implementations, if the UE receives a MAC CE that indicates a cell switch to a target serving cell, the UE may start/restart the TAT that corresponds to that target service cell.
(5) The UE may be configured with an IE/RRC parameter (e.g., CandidateServingCellGroup), which may include one or more additional IE/RRC parameters. Each of the additional IE/RRC parameters may correspond to a different candidate target serving cell configuration. The CandidateServingCellGroup may include TCI state information (e.g., for a DL TCI state, a UL TCI state, and/or a joint TCI state). Each TCI state indicated by the TCI information may be associated with a TAG ID. Additionally, a TAG ID may be associated with one or more TCI states indicated by the TCI state information. In some implementations, the TCI state information may include an AdditionalPCIIndex. The SSB-MTC-AdditionalPCI that corresponds to the AdditionalPCIIndex may include a TAG ID. In some implementations, the TCI state information may include a TAG ID. A TAG ID may be associated with one or more TCI states.
(6) An IE/RRC parameter used to indicate a candidate target serving cell configuration may include the TCI state information. In some implementations, the TCI information may include/indicate one or more TCI states (e.g., the DL TCI state(s), the UL TCI state(s), and/or the joint TCI state(s)).
(7) An IE/RRC parameter used to indicate a candidate target serving cell configuration may include one or more SSB burst set configurations. The SSB burst set configuration may include/indicate the maximum number of SSBs within an SSB burst set, and/or an SSB mapping pattern. The candidate target serving cell configuration may include one or more cell IDs for identifying the (candidate target serving) cells. Each cell ID may be in the form of an AdditionalPCIIndex, a serving cell index, or a PCI. The one or more SSB burst set configurations may be associated with one or more of the cells. The UE may perform DL synchronization to the target serving cell based on the one or more SSB burst set configurations after/at the time a serving cell beam change is triggered.
(8) An IE/RRC parameter used to indicate a candidate target serving cell configuration may include one or more CSI-RS configurations. The candidate target serving cell configuration may include one or more cell IDs for identifying the (candidate target serving) cells. Each cell ID may be in the form of an AdditionalPCIIndex, a serving cell index, or a PCI. The one or more CSI-RS configurations may be associated with one or more of the cells. The UE may perform DL synchronization to the target serving cell based on the one or more SSB burst set configurations after/at the time a serving cell/beam change is triggered.

In some implementations, a UE may be configured with one or more beam measurement window configurations to measure the RSRP and/or RSRQ corresponding to the beams (e.g., the SSB or the CSI-RS) of different candidate target serving cells and the source serving cell.

In some implementations, the beam measurement window configuration may include a measurement window periodicity/duration/timing offset. The beam measurement window for the target cell and the source cell may be the same or different. In some implementations, the UE may perform beam measurements within the beam measurement window associated with the target serving cell based on the beam measurement window configuration(s) associated with the target serving cell. In some implementations, the UE may perform beam measurements within the beam measurement window associated with the source serving cell based on the beam measurement window configuration(s) associated with the target serving cell.

In some implementations, the beam measurement window configuration may include the number of beam measurement windows used to calculate the average of the RSRP values corresponding to different beams associated with a candidate cell and/or the average of the RSRQ values corresponding to different beams associated with a candidate cell. For example, if the number of beam measurement windows (which is used to calculate the average of the RSRP values corresponding to different beams associated with a candidate target serving cell and or the average of the RSRQ values corresponding to different beams associated with a candidate target serving cell) is 2, the UE may provide a measurement report including the average of the RSRP values and or the average of the RSRQ values of the beams (e.g., the SSB or the CSI-RS) corresponding to different candidate target serving cells every two beam measurement windows. In some implementations, the beam measurement window may be in the unit of slots, sub-slots, milliseconds, seconds, frames, half-frames, and/or half-slots. In some implementations, the beam measurement window may vary based on the numerology of the BWP (on which the UE is monitoring data/information from the gNB or the UE is transmitting data/information to the gNB).

In some implementations, the beam measurement window configuration may include the number of candidate beams used to calculate the average of the RSRP values corresponding to different beams associated with a candidate target serving cell and/or the average of the RSRQ values corresponding to different beams associated with a candidate target serving cell, and thus the UE may provide a measurement report based on the candidate beams within a particular beam measurement window.

In some implementations, a candidate target serving cell configuration may include one or more CSI-RS configurations. Each CSI-RS configuration may include at least one of the following: the slot configuration(s) used to obtain the slot offset for the CSI-RS, the periodicity, the configurable measurement bandwidth for the CSI-RS, the parameters for a CSI-RS scrambling sequence, the configurable numerologies, and the CSI resource-related configurations (e.g., including CSI-measConfig, nZP-CSI-RS-Resource, CSI-SSB-Resource, CSI-IM-Resource, and/or CSI-ResourceConfig). In some implementations, the UE may transmit, to the source serving cell/gNB, a measurement report that includes the average of RSRP and/or RSRQ of the CSI-RSs determined based on different CSI-RS configurations. In some implementations, the UE may transmit, to the source serving cell/gNB, a measurement report corresponding to the maximum value of the measured RSRP and/or RSRQ of the CSI-RSs determined based on different CSI-RS configurations.

In some implementations, a candidate target serving cell configuration may include one or more TRS configurations. Each TRS configuration may include at least one of the following: the slot configuration(s) used to obtain the slot offset for the TRS, the periodicity, the configurable measurement bandwidth for the TRS, the configurable numerologies, and the TRS resource-related configuration including trs-ResourceSetConfig. In some implementations, the UE may transmit, to the source service cell/gNB, a measurement report that includes the average of RSRP and/or RSRQ of the TRSs determined based on different TRS configurations. In some implementations, the UE may transmit, to the source service cell/gNB, a measurement report corresponding to the maximum value of the measured RSRP and/or RSRQ of the TRSs determined based on different TRS configurations.

### Beam Measurement and Reporting

In some implementations, a UE may measure different SSBs corresponding to various candidate target serving cells within a measurement window (or time duration) configured by the source serving cell/gNB. If the RSRP of any SSB associated with a candidate target serving cell exceeds (or is equal to) a threshold value indicated by the network and/or source serving cell/gNB (e.g., via an RRC message or broadcast system information), the UE may initiate a RACH procedure. Specifically, the UE may transmit a preamble on the RO associated with the SSB that has an RSRP above the threshold value. Subsequently, the UE may transmit a beam measurement report, which corresponds to each measured beam (e.g., an SSB) of the candidate target serving cells within the measurement window, via the MSG3 and/or the MSGA (e.g., as part of the payload of the MSGA) to the source serving cell/gNB.

In some implementations, a UE may measure different SSBs corresponding to various candidate target serving cells, based on an associated measurement window (or time duration) configured by the source serving cell/gNB.

In some implementations, one or more L1/L2 mobility-dedicated ROs may be configured for a UE. The UE may measure different CSI-RSs corresponding to different candidate target serving cells within a measurement window (or time duration) configured by the source serving cell/gNB. Thereafter, the UE may initiate a RACH procedure and transmit a preamble using the L1/L2 mobility-dedicated RO(s). The L1 L2 mobility-dedicated ROs may be the Ros that are specifically applied for the L1/L2 mobility operations. The UE may transmit a beam measurement report, corresponding to each measured beam (e.g., a CSI-RS) of the candidate target serving cells measured in a measurement window, via the MSG3 and/or the MSGA.

In some implementations, the beam measurement report corresponding to different candidate target serving cells may be included in a MAC CE transmitted on the UL grant requested by the Scheduling Request (SR).

In some implementations, a UE may report L1/L2-related measurement results (e.g., beam measurement results) via an available UL grant. If no UL grant is available for transmitting the L1/L2-related measurement results, the UE may transmit an SR on a valid PUCCI resource, if configured. The network may transmit to the UE an SR configuration associated with L1/L2-related measurement reporting. If such an SR configuration is configured, the UE may transmit an SR on a valid PUCCH resource configured by the SR configuration when no UL grant is available for transmitting the L1/L2-related measurement results. In a case that no SR configuration associated with L1/L2-related measurement reporting exists, the UE may apply/use the SR configuration(s) associated with the current active BWP to perform the SR transmission, if any are available. If no valid PUCCH resource for the SR transmission is available, the UE may initiate a RACHI procedure to report the L1/L2-related measurement results.

In some implementations, the L1/L2-related measurement result may include a beam ID (e.g., an SSB ID, a CSI-RS ID, or a TRS ID) and/or the associated measurement results (e.g., the RSRP value(s) and/or the RSRQ value(s)) that fulfill the reporting criteria specified by the associated reporting configurations for the L1/L2-related measurements. In some implementations, the network may configure whether the beam ID and/or the associated measurement results should be included in the L1/L2-related measurement results from the UE.

### TA Acquisition

In some implementations, a MAC CE may be used to initiate the change of the serving cell. In some such implementations, the MAC CE may be associated with a specific Logical ChannelID (LCID). In some implementations, a TA MAC CE may be used to initiate the change of the serving cell. The UE may switch to the candidate target serving cell corresponding to the TAG ID included in the TA MAC CE in response to receiving the TA MAC CE. Each candidate target serving cell may be associated with a respective TAG ID.

In some implementations, a MAC CE (e.g., a cell-switching command MAC CE) may include a field that indicates the identification of the target cell. If the UE is instructed to switch to the target cell (e.g., in response to receiving the MAC CE), the UE may start or restart the TAT associated with that target cell. Alternatively, if the UE is instructed to switch to the target cell (e.g., in response to receiving the MAC CE), the associated TAT may keep running.

In some implementations, the DCI may be used to initiate a change of the serving cell. For example, the DCI transmitted by the source serving cell/gNB may include an AdditionalPCIIndex field to inform the UE about which candidate target serving cell to switch to. The TA value for the target serving cell may be provided through a TA MAC CE. The TAG ID included in the TA MAC CE may be associated with one or more candidate target serving cells.

In some implementations, the UE may be configured with one or more ROs dedicated to the L1/L2 mobility operations. For example, a single RO may be associated with multiple SSBs corresponding to various candidate target serving cells. If the source serving cell/gNB instructs the UE to perform a serving cell change, the UE may transmit a preamble on the dedicated RO to initiate the serving cell change.

In some implementations, a UE may be configured with one or more preamble groups dedicated to the L1 L2 mobility operations. Each preamble group may be associated with one or more candidate target serving cells. The information of the preamble group(s) may be included in the information associated with the candidate target serving cells.

In some implementations, the TA value for the target serving cell may be determined based on the TA value for the source serving cell, in a case that at least one of the following conditions (1) to (3) is met:
(1) The UE is configured with an RSRP threshold, and the RSRP value for the target serving cell is larger than or equal to the configured RSRP threshold. The configured RSRP threshold may be set through a pre-configuration or the received RRC configuration/message from the source serving cell/gNB.
(2) The UE is configured with an RSTD threshold, and the absolute value of the RSTD for the target serving cell is less than the RSTD threshold. In some implementations, the UE may be configured with the RSTD threshold after/at the time the UE receives an RRC message (e.g., an RRC reconfiguration message) including the RSTD threshold.
(3) The UE is configured with a delta value, and the difference between the RSRP value for the source serving cell and the RSRP value for the target serving cell is less than or equal to the delta value. The UE may be configured with the delta value after/at the time the UE receives an RRC message (e.g., an RRC reconfiguration message) including the delta value.

In some implementations, a timer may be configured to instruct the UE to use the TA value for the source serving cell as the TA value for the target serving cell directly. The UE may restart or start the timer upon receiving a configuration that includes a timer value that the UE is able to set to the timer. In some implementations, the UE may restart or start the timer when the UE receives a MAC CE or a DCI, both of which are used to initiate a change in the serving cell. After/when the timer expires, the UE may initiate a RACHI procedure to obtain the TA value for the target serving cell. In a case that the TA value for the source serving cell is updated by the network, the source serving cell/gNB, and/or the target serving cell/gNB (e.g., via dedicated signaling or broadcast system information), the UE may (re)start the timer. In some implementations, when restarting the timer, the UE may set the timer to a value configured by the network, the source serving cell/gNB, and/or the target serving cell/gNB (e.g., via dedicated signaling or broadcast system information).

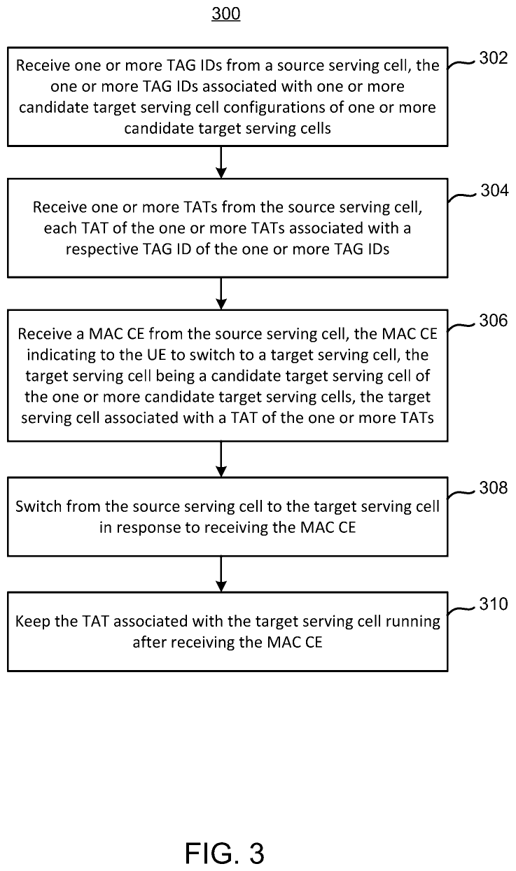

FIG. 3 is a flowchart of a method 300 for cell switching operations (e.g., L1/L2 mobility operations), according to an example implementation of the present disclosure. It should be noted that although actions 302, 304, 306, 308, and 310 are illustrated as separate actions represented as independent blocks in FIG. 3, these separately illustrated actions should not be construed as necessarily order-dependent. The order in which the actions are performed in FIG. 3 is not intended to be construed as a limitation, and any number of the disclosed blocks may be combined in any order to implement the method, or an alternate method. Moreover, each of actions 302, 304, 306, 308, and 310 may be performed independently of other actions and may be omitted in some implementations of the present disclosure.

In action 302, the UE may receive one or more TAG IDs from a source serving cell. The one or more TAG IDs are associated with one or more candidate target serving cell configurations of one or more candidate target serving cells.

In action 304, the UE may receive one or more TATs from the source serving cell. Each TAT of the one or more TATs is associated with a respective TAG ID of the one or more TAG IDs. For example, a one-to-one correspondence may exist between the TATs and the TAG IDs.

In action 306, the UE may receive a MAC CE from the source serving cell. The MAC CE may indicate to the UE to switch to a target serving cell. The target serving cell may be a candidate target serving cell of the one or more candidate target serving cells, and the target serving cell may be associated with a TAT of the one or more TATs.

In action 308, the UE may switch from the source serving cell to the target serving cell in response to receiving the MAC CE.

In action 310, the UE may keep the TAT associated with the target serving cell running after receiving the MAC CE.

In some implementations, each candidate target serving cell configuration of the one or more candidate target serving cell configurations may be associated with an SSB configuration that indicates at least one of an SSB burst set, a transmission power of an SSB, or a periodicity of the SSB.

In some implementations, the source serving cell may be associated with a first PCI, and the target serving may be is associated with a second PCI that is different from the first PCI of the serving cell.

In some implementations, the MAC CE may include a field that indicates the target serving cell.

Leveraging method 300, the latency of performing cell switching operations in wireless communication networks is significantly reduced. Through lower layer signaling (e.g., the MAC CE) and measurement (e.g., L1 measurement), the UE is able to quickly switch to a target serving cell without the need for lengthy measurements and adjustments. Method 300 ensures a more efficient transition, minimizing service interruptions and enhancing user experience.

It should be noted that in the present disclosure, the BS may perform methods/actions corresponding to those performed by the UE. For example, the receiving actions performed by the UE may correspond to the transmitting/configuring actions of the BS; the transmitting actions performed by the UE may correspond to the receiving actions of the BS. That is, the BS and the UE may have reciprocally aligned roles in transmission and reception. Consequently, the methods or actions executed by the BS may be combined or integrated in a similar manner to how the methods or actions are executed by the UE.

For example, when viewed from the BS's perspective, method 300 may correspond to a method performed by the BS. Specifically, the BS may configure the UE with one or more TAG IDs, where the one or more TAG IDs may be associated with one or more candidate target serving cell configurations of one or more candidate target serving cells. The BS may also configure the UE with one or more TATs, where each TAT of the one or more TATs may be associated with a respective TAG ID of the one or more TAG IDs. The BS may transmit a MAC CE to the UE. The MAC CE may indicate to the UE to switch to a target serving cell, where the target serving cell may be a candidate target serving cell of the one or more candidate target serving cells, and the target serving cell may be associated with a TAT of the one or more TATs. The TAT associated with the target serving cell may be configured to keep running after the UE receives the MAC CE. Specifically, the TAT may keep running even after the UE receives the MAC CE.

In some implementations, each candidate target serving cell configuration of the one or more candidate target serving cell configurations may be associated with an SSB configuration that indicates at least one of an SSB burst set, a transmission power of an SSB, or a periodicity of the SSB.

In some implementations, the BS may provide a source serving cell that is associated with a first PCI. The target serving cell may be associated with a second PCI that is different from the first PCI of the source serving cell.

In some implementations, the MAC CE may include a field that indicates the target serving cell.

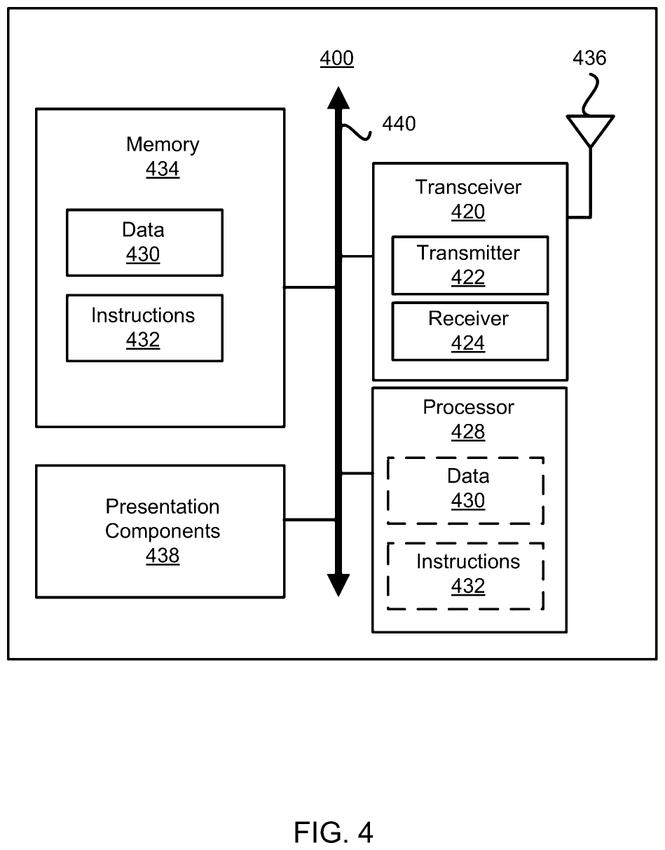

FIG. 4 is a block diagram illustrating a node for wireless communication in accordance with various aspects of the present disclosure. As illustrated in FIG. 4, node 400 may include transceiver 420, processor 428, memory 434, one or more presentation components 438, and at least one antenna 436. Node 400 may also include a radio frequency (RF) spectrum band module, a BS communications module, a network communications module, and a system communications management module, Input/Output (I/O) ports, I/O components, and a power supply (not illustrated in FIG. 4).

Each of the components may directly or indirectly communicate with each other over one or more buses 440. Node 400 may be a UE or a BS that performs various functions disclosed with reference to FIGS. 1 through 3.

Transceiver 420 has transmitter 422 (e.g., transmitting/transmission circuitry) and receiver 424 (e.g., receiving/reception circuitry) and may be configured to transmit and/or receive time and/or frequency resource partitioning information. Transceiver 420 may be configured to transmit in different types of subframes and slots including, but not limited to, usable, non-usable, and flexibly usable subframes and slot formats. Transceiver 420 may be configured to receive data and control channels.

Node 400 may include a variety of computer-readable media. Computer-readable media may be any available media that may be accessed by node 400 and include volatile (and/or non-volatile) media and removable (and/or non-removable) media.

The computer-readable media may include computer-storage media and communication media. Computer-storage media may include both volatile (and/or non-volatile media), and removable (and/or non-removable) media implemented in any method or technology for storage of information such as computer-readable instructions, data structures, program modules, or data.

Computer-storage media may include RAM, ROM, EPROM, EEPROM, flash memory (or other memory technology), CD-ROM, Digital Versatile Disks (DVD) (or other optical disk storage), magnetic cassettes, magnetic tape, magnetic disk storage (or other magnetic storage devices), etc. Computer-storage media may not include a propagated data signal. Communication media may typically embody computer-readable instructions, data structures, program modules, or other data in a modulated data signal, such as a carrier wave, or other transport mechanisms and include any information delivery media.

The term “modulated data signal” may mean a signal that has one or more of its characteristics set or changed in such a manner as to encode information in the signal. Communication media may include wired media, such as a wired network or direct-wired connection, and wireless media, such as acoustic, RF, infrared, and other wireless media. Combinations of any of the previously listed components should also be included within the scope of computer-readable media.

Memory 434 may include computer-storage media in the form of volatile and/or non-volatile memory. Memory 434 may be removable, non-removable, or a combination thereof. Example memory may include solid-state memory, hard drives, optical-disc drives, etc. As illustrated in FIG. 4, memory 434 may store a computer-readable and or computer-executable instructions 432 (e.g., software codes) that are configured to, when executed, cause processor 428 to perform various functions disclosed herein, for example, with reference to FIGS. 1 through 3. Alternatively, instructions 432 may not be directly executable by processor 428 but may be configured to cause node 400 (e.g., when compiled and executed) to perform various functions disclosed herein.

Processor 428 (e.g., having processing circuitry) may include an intelligent hardware device, e.g., a Central Processing Unit (CPU), a microcontroller, an ASIC, etc. Processor 428 may include memory. Processor 428 may process data 430 and instructions 432 received from memory 434, and information transmitted and received via transceiver 420, the baseband communications module, and/or the network communications module. Processor 428 may also process information to send to transceiver 420 for transmission via antenna 436 to the network communications module for transmission to a CN.

One or more presentation components 438 may present data indications to a person or another device. Examples of presentation components 438 may include a display device, a speaker, a printing component, a vibrating component, etc.

In view of the present disclosure, it is obvious that various techniques may be used for implementing the disclosed concepts without departing from the scope of those concepts. Moreover, while the concepts have been disclosed with specific reference to certain implementations, a person of ordinary skill in the art may recognize that changes may be made in form and detail without departing from the scope of those concepts. As such, the disclosed implementations are to be considered in all respects as illustrative and not restrictive. It should also be understood that the present disclosure is not limited to the particular implementations disclosed and many rearrangements, modifications, and substitutions are possible without departing from the scope of the present disclosure.

1. A method performed by a User Equipment (UE) for cell switching operations, the method comprising:
receiving one or more Timing Advance Group (TAG) Identities (IDs) from a source serving cell, the one or more TAG IDs associated with one or more candidate target serving cell configurations of one or more candidate target serving cells;
receiving one or more Time Alignment Timers (TATs) from the source serving cell, each TAT of the one or more TATs associated with a respective TAG ID of the one or more TAG IDs;
receiving a Medium Access Control (MAC) Control Element (CE) from the source serving cell, the MAC CE indicating to the UE to switch to a target serving cell, the target serving cell being a candidate target serving cell of the one or more candidate target serving cells and being associated with a TAT of the one or more TATs;
switching from the source serving cell to the target serving cell in response to receiving the MAC CE; and
keeping the TAT associated with the target serving cell running after receiving the MAC CE.

2-4. (canceled)

5. A User Equipment (UE) for cell switching operations, the UE comprising:
at least one processor; and
at least one non-transitory computer-readable medium coupled to the at least one processor and storing one or more computer-executable instructions that, when executed by the at least one processor, cause the UE to:
receive one or more Timing Advance Group (TAG) Identities (IDs) from a source serving cell, the one or more TAG IDs associated with one or more candidate target serving cell configurations of one or more candidate target serving cells;
receive one or more Time Alignment Timers (TATs) from the source serving cell, each TAT of the one or more TATs associated with a respective TAG ID of the one or more TAG IDs;
receive a Medium Access Control (MAC) Control Element (CE) from the source serving cell, the MAC CE indicating to the UE to switch to a target serving cell, the target serving cell being a candidate target serving cell of the one or more candidate target serving cells and being associated with a TAT of the one or more TATs;
switch from the source serving cell to the target serving cell in response to receiving the MAC CE; and
keep the TAT associated with the target serving cell running after receiving the MAC CE.

6. The UE of claim 5, wherein each candidate target serving cell configuration of the one or more candidate target serving cell configurations is associated with a Synchronization Signal and Physical Broadcast Channel Block (SSB) configuration that indicates at least one of an SSB burst set,
a transmission power of an SSB, or
a periodicity of the SSB.

7. The UE of claim 5, wherein the source serving cell is associated with a first Physical Cell Identity (PCI), and the target serving cell is associated with a second PCI that is different from the first PCI associated with the source serving cell.

8. The UE of claim 5, wherein the MAC CE comprises a field that indicates the target serving cell.

9. A Base Station (BS) for managing cell switching operations of a User Equipment (UE), the BS comprising:
at least one processor; and
at least one non-transitory computer-readable medium coupled to the at least one processor and storing one or more computer-executable instructions that, when executed by the at least one processor, cause the UE to:
configure the UE with one or more Timing Advance Group (TAG) Identities (IDs), the one or more TAG IDs associated with one or more candidate target serving cell configurations of one or more candidate target serving cells;
configure the UE with one or more Time Alignment Timers (TATs), each TAT of the one or more TATs associated with a respective TAG ID of the one or more TAG IDs; and
transmit a Medium Access Control (MAC) Control Element (CE) to the UE, the MAC CE indicating to the UE to switch to a target serving cell, the target serving cell being a candidate target serving cell of the one or more candidate target serving cells and being associated with a TAT of the one or more TATs,
wherein the TAT associated with the target serving cell is configured to keep running after the UE receives the MAC CE.

10. The BS of claim 9, wherein each candidate target serving cell configuration of the one or more candidate target serving cell configurations is associated with a Synchronization Signal and Physical Broadcast Channel Block (SSB) configuration that indicates at least one of an SSB burst set,
a transmission power of an SSB, or
a periodicity of the SSB.

11. The BS of claim 9, wherein the BS is configured to provide, for the UE, a source serving cell that is associated with a first Physical Cell Identity (PCI), and the target serving cell is associated with a second PCI that is different from the first PCI associated with the source serving cell.

12. The BS of claim 9, wherein the MAC CE comprises a field that indicates the target serving cell.
